(19) United States
(12) Patent Application Publication
(10) Pub. No.: US 2020/0091795 A1
(43) Pub. Date: Mar. 19, 2020

(54) Rotor Shaft Retainer

(71) Applicant: EMICOL Eletro Eletrônica S.A., Itu (BR)

(72) Inventors: Peter Friedrich, Itu (BR); Fernando Barbosa Silva, Itu (BR)

(21) Appl. No.: 16/567,274

(22) Filed: Sep. 11, 2019

(30) Foreign Application Priority Data
Sep. 17, 2018 (BR) 10 2018 068836-7

(51) Int. Cl. H02K 5/16

(52) U.S. Cl. CPC H02K 5/163; F04D 13/06

(57) ABSTRACT

A rotor shaft retainer is described, preferably to be used in an electric pump intended for use in white line equipment, and in particular to be coupled to the upper edge of the housing of the electric pump, and capable of allowing sealing of the shaft passing therethrough. The retainer has a basically cylindrical shape and includes a disc-shaped base, externally provided with a fixing ring, and a cylindrical dome uppermost provided with an opening, defining a central passageway formed from the opening to a lower opening of the base. The central passageway includes at least two annular lips-shaped cavities projecting themselves in the inner radial direction and facing the upper opening of the retainer. The lips-shaped cavities are made of rubber having Shore A hardness from 62 to 78 and define respective angles from 38 to 58 degrees in relation to the plane of the bottom surface of the base. Such construction and characteristics lead to a sufficient seal between the shaft and the retainer and still allow the relief of the gases generated within the pump chamber, without the need for relief holes in the retainer body.

### CROSS-REFERENCE TO RELATED APPLICATION

This application claims priority to Brazilian Patent Application No. 10 2018 068836-7 filed Sep. 17, 2018, the disclosure of which is hereby incorporated by reference in its entirety.

### BACKGROUND OF THE INVENTION

### Field of the Invention

The present invention relates to an isolation retainer between an external zone and an internal zone of an electric pump, through which the electric pump rotor is projected. More particularly, the present invention relates to a retainer particularly applied to the rotor shaft of an electric pump of white line equipment.

### Description of Related Art

As known in the state of art, retainers are elements designed to isolate adjacent zones and between said zones a shaft or mechanical element generally moves in. Their primary function is to prevent direct contact between said adjacent zones, which usually define different conditions. Particularly in regard to the equipment known as white line, the retainers are provided, for example, to isolate the zone surrounding an electric pump from the zone in which the fluid to be pumped is located.

In some more specific applications, said electric pump is enclosed in a chamber (internal zone) isolated from the environment (external zone) in order to avoid deleterious effects, either by the presence of water (from washing and/or rinsing) or by the presence of particulates and contaminants in the air surrounding said pump.

In this particular case, with the electric pump enclosed in a closed chamber, the electric motor driving the driving shaft is powered by an electric current and, as known, this produces heat during the conversion from electricity to movement. Such heat emanates within the chamber, thereby increasing the internal pressure of the chamber. In order to prevent the internal pressure from assuming values above the acceptable ones in design, from which a chamber seal impairment and/or a rotor assembly locking may occur, among other problems, the state of art presents a solution in which the retainer employed has an exhaust port, which allows internal pressure relief but impairs the tightness of the internal zone.

In addition, not only can the electric pump be exposed to external agents but also other components enclosed in said chamber, such as the bearing of the electric pump. In this case, the possible penetration of particles into the bearing that support and position the drive shaft may lead to premature bearing impairment due to grooves emergence or deformations of the bearing.

US 2014 041466 and U.S. Pat. No. 8,376,369 describe a retainer for isolation between internal oiled zone and external air zone whereas helical grooves are provided to push oil into its reservoir and to push air out of the oil reservoir. Although the inventive concept is not innovative, such a solution has its efficiency impaired in the condition of stopped shaft, i.e. without rotation.

BRPI 0401042 describes an oil retainer whereas the seal includes passages to create an internal pressure relief path.

### SUMMARY OF THE INVENTION

Thus, it is a first object of the present invention a retainer particularly provided for an electrical pump of white line equipment, which allows the isolation of the internal zone from the external zone, but allowing the internal pressure relief.

These and other objects are achieved from a rotor shaft retainer, preferably to be provided in an electric pump to be used in white line equipment, and in particular to be coupled to the upper edge of the electric pump housing and capable of permitting the sealing of the shaft passing therethrough, said retainer having a basically cylindrical shape and composed of a disc shaped base, externally provided with a fixing ring and a cylindrical dome which is uppermost provided with an opening, defining a central passageway formed from said opening to a lower base opening. In particular, the central passageway comprises at least two lips-shaped annular cavities, projecting themselves in the inner radial direction and facing the upper opening of the retainer, and, at least, said lips-shaped cavities being made of rubber having a Shore A hardness of 62 to 78 and defining respective angles from 38 to 58 degrees in relation of the bottom surface plane of the base.

In particular, said retainer comprises three lips-shaped cavities with an inclination angle from 43 and 53 degrees. In addition, between each lips-shaped annular cavity and its upper adjacent is defined a chamber partially filled with grease having a kinematic viscosity at 40° C. of about 220 mm²/s.

### BRIEF DESCRIPTION OF THE FIGURES

The object of the present invention will be better defined and understood from the detailed description of a preferred embodiment thereof, which is made accompanied by the attached illustrative and non-limiting figures, in which:

FIG. 1 is a cross-sectional view of a retainer according to the invention; and

FIG. 2 is a cross-sectional view of the retainer of FIG. 1 used in an electric pump.

### DESCRIPTION OF THE INVENTION

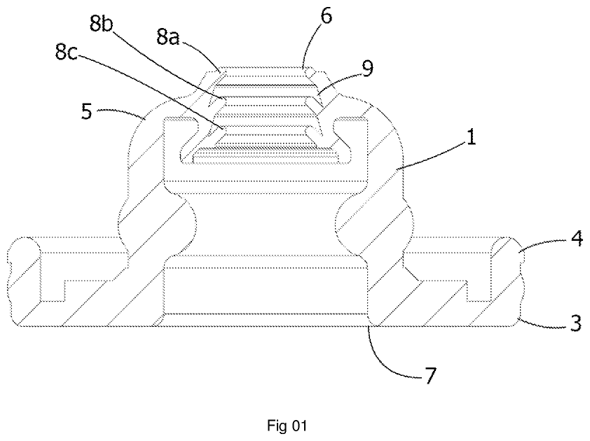

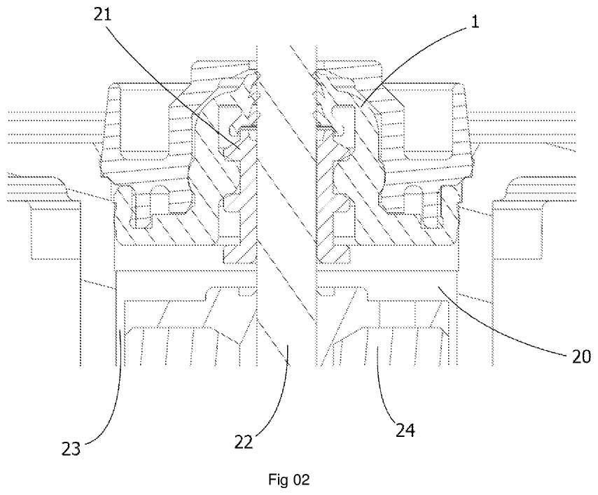

In accordance with FIG. 1 and FIG. 2, (1) generally indicates a retainer for an electric pump (20), in particular an electric pump intended to be used in white line equipment. Said retainer (1) is a cylindrical part and basically formed by a disc-shaped base (3), externally provided with a fixing ring (4). In the central portion of the retainer is defined a cylindrical dome (5) uppermost provided with an opening (6) through which the drive shaft of the pump (20) moves. More specifically, said retainer (1) defines a central passageway (2) formed from said opening (6) of the dome (5) to a lower opening (7) of the base (3). Furthermore, the central passageway (2) is internally shaped to receive or to be coupled to the bearing (21) of the electric pump (20) through which said drive shaft (22) projects itself.

With particular reference to FIG. 2, which also illustrates the electric pump (20), said the electric pump (20) comprises the mentioned drive shaft (21), uppermost (relative to FIG. 2) sustained and maintained in a rotational position by a first bearing (21) and by a second lower bearing (not shown), arranged in longitudinal opposition to the bearing (21), both duly fixed to the housing (23) of the electric pump (20). Finally, within the electric pump there is further provided a stator (24) which induces the rotation of the drive shaft (22), or rotor, when powered by an electric current.

In accordance with the illustration of FIG. 1, said dome (5) internally comprises a retention structure, which is defined by the lips-shaped annular cavities (8a-c). Said lips-shaped annular cavities (8a-c) are shown in stacked way, equidistant and have similar conformation, arranged angularly with radially internal and longitudinally projection upward.

More particularly, the angle defined between any of said lips-shaped annular cavities (8a-8c) and the horizontal plane, which is the plane defined by the base (3), is 38 to 58 degrees, and more particularly from 43 and 53 degrees. In addition, and preferably, the respective inclination angles of each of the lips-shaped annular cavities are equal. However, and depending on the particular characteristics of the electric pump, its rotor shaft, and other factors, it is possible to define each of the inclination angles with respective different values, but always within the limits now established.

In addition, and in order that the desired results of sealing, gas exhaust and useful life are achieved by the retainer, in accordance with the present invention, it is further desired that said retainer, and in particular said lips-shaped cavities (8a-8c) are made from natural or synthetic rubber having a Shore A hardness between 62 and 78.

In the various tests carried out by the inventors, it has been established that the combination of the above parameters for lips-shaped cavities arrangement, as determined, is effective for achieving the desired sealing results between the shaft (22) of the electric pump (20), as well as the durability of the retainer itself.

In addition, between each lips-shaped annular cavity (8) and its upper adjacent one is defined a chamber (9) for receiving a lubricating/retaining material of particulates, contaminants and the like. Preferably, and in order to allow retention of any particulate material which eventually penetrates the shaft/lips-shaped cavity seal, each of said chambers (9) is partially filled with a grease which has a kinematic viscosity at 40° C., about 220 mm²/s.

Thus, according to said tests and trials carried out, it has been found that the retainer, as defined herein, ensures a very effective sealing of the rotating shaft (22) against possible penetration of particles, such as sand and others, inside the electric pump, but without impairing the gas relief capability coming from the electric pump chamber. In addition, a retainer thus defined has a very significant useful life, safeguarding the integrity of the electric pump and its shaft.

1. A rotor shaft retainer, preferably to be used in an electric pump intended for use in white line equipment, and in particular to be coupled to the upper edge of the electric pump housing, and capable of allowing sealing of the shaft passing therethrough, said retainer having a basically cylindrical shape and consisting of a disc-shaped base externally provided with fixing ring and a cylindrical dome uppermost provided with an opening, defining a central passageway formed from said opening to a lower opening of the base, whereas the central passageway comprises at least two lips-shaped annular cavities projecting themselves in the inner radial direction and facing the upper opening of the retainer, at least said lips-shaped cavities being made of rubber having a Shore A hardness of 62 to 78, and defining respective angles between 38 and 58 degrees in relation to the plane of the bottom surface of the base.

2. The rotor shaft retainer according to claim 1, wherein it comprises three lips-shaped cavities with an inclination angle between 43 and 53 degrees.

3. The rotor shaft retainer according to claim 1, wherein between each annular lips-shaped cavity and its upper adjacent one is defined a chamber partially filled with grease having a kinematic viscosity at 40° C. of about 220 mm²/s.
